(19) United States
(12) Patent Application Publication
(10) Pub. No.: US 2024/0326878 A1
(43) Pub. Date: Oct. 3, 2024

(54) METHOD AND SYSTEM FOR SWITCHING FROM AUTONOMOUS TO DRIVER'S MODE IN A MOTOR VEHICLE

(71) Applicant: Panasonic Automotive Systems Company of America, Division of Panasonic Corporation of North America, PEACHTREE CITY, GA (US)

(72) Inventor: ANDRII DANYLOV, PEACHTREE CITY, GA (US)

(21) Appl. No.: 18/619,020

(22) Filed: Mar. 27, 2024

Related U.S. Application Data
(60) Provisional application No. 63/455,553, filed on Mar. 29, 2023.

(51) Int. Cl. B60W 60/00; B60H 1/00; B60W 40/08; B60W 50/14

(52) U.S. Cl. CPC B60W 60/0059; B60H 1/00742; B60W 40/08; B60W 50/14; B60W 60/0053; B60W 60/0057; B60W 2050/143; B60W 2420/403; B60W 2420/54

(57) ABSTRACT

An autonomous driving arrangement for a motor vehicle having wheels includes an autonomous driving system, and a sensor detecting a condition of a human driver. A driving control device is engaged by a hand or foot of the driver to thereby enable the driver to control the wheels by engaging the driving control device. An electronic processor is communicatively coupled to each of the autonomous driving system, the sensor, and the driving control device. The processor receives signals from the sensor. In response to the signals indicating that the driver is ready to drive the motor vehicle, the processor enables the driving control device and disables the autonomous driving system. In response to the signals indicating that the driver is unready to drive the motor vehicle, the processor refrains from enabling the driving control device and continues to enable the autonomous driving system to control the wheels.

### CROSS-REFERENCED TO RELATED APPLICATIONS

This application claims benefit of U.S. Provisional Application No. 63/455,553, filed on Mar. 29, 2023, the disclosure of which is hereby incorporated by reference in its entirety for all purposes.

### BACKGROUND OF THE INVENTION

### 1. Field of the Invention

The present invention relates to a motor vehicle capable of autonomous driving.

### 2. Description of the Related Art

There are a lot of known issues with switching the autonomous driving mode on and off for L2+ type autonomous cars, and for any other systems in the sky, sea, underground, or on the ground with remote or direct control, where a user has to switch from human control to autonomous control or vice versa. These issues may occur with any mix of software and hardware, because of the need for interaction between the human driver and the robot driver system. Enabling of the autonomous driving system usually does not cause a problem, but disabling the system is always problematic and risky because it can cause a hazard.

Current working solutions provide something simple and easy such as the driver pressing a single pushbutton, or detecting that the driver is holding his hands on the steering wheel. However, these known solutions do not work well in all cases and under all conditions.

### SUMMARY OF THE INVENTION

The invention may enable safe interaction between a human driver and an autonomous driving system to give control of the vehicle to the driver only when the driver is ready for it. Particularly, the invention may provide a way to use computer vision algorithms, hands-on detection, voice and pushbuttons for switching from an autonomous driving mode to a normal human driving mode.

When a vehicle or transportation system is moving in the autonomous driving mode and the driver wants to switch it back to the manual driving mode, a driver monitoring system observes the driver's head. For example, driver monitoring system may determine where the driver's head is in three-dimensional space, and the direction in which the driver's eyes are directed. In order to safely switch to the manual driving mode, the driver should be looking in the direction in which the vehicle is moving, should not be drowsy, distracted, drunk, or unconscious. Depending on the level of autonomous driving, the driver's hands should be on or off the steering wheel, as may be detected by both computer vision and a hands-on detection system. Instead of a steering wheel and pedals, the invention can be applied to any other type of control system. Monitoring should be appropriate to that control system according to protocols of human readiness to start driving/piloting that particular control system.

The driver may switch off the autonomous driving system by pressing a button, touching a screen, or providing a voice command or gesture that may be recognized by the driver monitoring system. The system may recognize this command and give feedback to the human that the command has been accepted.

Some time for transition may be called for before and/or during the switch from autonomous control to the manual mode controlled by a human. This time may be flexible depending on the situation and the type of vehicle or type of transportation. For example, assume that five seconds are spent in the transition state. Displayed on a screen or windshield for the driver to see may be a decremented counter with seconds remaining until the manual mode is implemented. Also, the vehicle multimedia system can duplicate the counting using an audible voice: “five, four, three, two, one, start.”

During the decrementing of time until the switch to driver manual control of the vehicle, the driver monitoring system may monitor the human driver to verify that he remains ready to take control. For example, it may be verified that the driver is not drowsy, distracted, drunk, unconscious, or looking at his phone or other screen. It may be verified that the driver's head is oriented correctly for watching the road, and that his eyes are watching the correct zone. The hands-on detection system and/or the driver monitoring system may monitor the readiness of the driver's hands for driving. The heartbeat and temperature of the driver may be monitored to verify that the driver has not died. That is, he has a pulse and his body is not cold. In case that any hazard state detected indicating that the driver is not ready to take over control of the vehicle, the autonomous driving system may immediately cancel the counter and not switch from autonomous driving mode to manual driver's mode. The human driver may also be able to cancel the transition to manual driver's mode if he is not ready to begin driving, and then the transition process from autonomous driving to manual human driving may begin anew from step one.

Depending on the detected conditions and the type of vehicle or transportation, if there is some indication that the driver is not ready to drive, the autonomous system can ask the driver if it may repeat the switching process from the first step, or it may inform the driver that it is doing so. It is also possible for the autonomous system to request a change of the human driver and possibly repeat the switching process from autonomous driving to manual human driving with a new person. It is further possible for the autonomous system to blow cold air on the human driver or emit loud sounds from the vehicle audio system in order to wake the driver from drowsiness to a normal awake state of alertness.

If the autonomous system detects that the human cannot drive safely drive the vehicle, then the system may perform steps to reduce risks as much as possible and do all possible steps to save the driver's health and life. If the vehicle is automated and autonomous to a high enough level and conditions are good for autonomous driving, the system can bring the human driver to the nearest hospital. If the risks associated with attempting to deliver the human to the hospital are too high, then the system may exit from the street or highway safely and park in the nearest parking space and call emergency 911. The system may also signal to nearby drivers/cars using sound and lights in order to request them to get help. If the autonomous system is in an airplane, then it should land the airplane safely, etc.

The invention comprises, in one form thereof, an autonomous driving arrangement for a motor vehicle having wheels. The arrangement includes an autonomous driving system, and at least one sensor detecting a condition of a human driver of the motor vehicle. At least one driving control device is engaged by a hand or foot of the human driver to thereby enable the human driver to control the wheels of the motor vehicle by engaging the driving control device. An electronic processor is communicatively coupled to each of the autonomous driving system, the at least one sensor, and the at least one driving control device. The electronic processor receives signals from the at least one sensor. In response to the signals indicating that the human driver is ready to drive the motor vehicle, the electronic processor enables the at least one driving control device and disables the autonomous driving system. In response to the signals indicating that the human driver is unready to drive the motor vehicle, the electronic processor refrains from enabling the at least one driving control device and continues to enable the autonomous driving system to control the wheels of the motor vehicle.

The invention comprises, in another form thereof, a method for autonomously driving a motor vehicle having wheels, including providing an autonomous driving system. A condition of a human driver of the motor vehicle is detected. At least one driving control device is provided. The driving control device is configured to be engaged by a hand or foot of the human driver to thereby enable the human driver to control the wheels of the motor vehicle by engaging the driving control device. In response to the detecting step detecting that the human driver is ready to drive the motor vehicle, the at least one driving control device is enabled, and the autonomous driving system is disabled. In response to the detecting step detecting that the human driver is unready to drive the motor vehicle, the at least one driving control device is not enabled, and the autonomous driving system is continued to be enabled to control the wheels of the motor vehicle.

The invention comprises, in yet another form thereof, an autonomous driving arrangement for a motor vehicle having wheels. The arrangement includes an autonomous driving system, at least one readiness sensor configured to detect whether a human driver is ready to take over driving tasks of the motor vehicle, and at least one driving control device. The at least one driving control device is configured to be engaged by a hand or foot of the human driver to thereby enable the human driver to control the wheels of the motor vehicle by engaging the driving control device. At least one driver body sensor is configured to detect whether the human driver is having a health emergency. An electronic processor is communicatively coupled to each of the autonomous driving system, the at least one readiness sensor, the at least one driving control device, and the at least one driver body sensor. The electronic processor receives readiness signals from the at least one readiness sensor. In response to the readiness signals indicating that the human driver is ready to drive the motor vehicle, the electronic processor enables the at least one driving control device and disables the autonomous driving system. In response to the readiness signals indicating that the human driver is unready to drive the motor vehicle, the electronic processor refrains from enabling the at least one driving control device and continue to enable the autonomous driving system to control the wheels of the motor vehicle. The electronic processor receives health signals from the at least one driver body sensor. In response to the health signals indicating that the human driver is having a health emergency, the electronic processor uses the autonomous driving system to drive the motor vehicle to a location where the human driver can be accessed by a human emergency responder.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an autonomous driving control arrangement of the present invention for a motor vehicle.

FIG. 2 is a flow chart of one embodiment of an autonomous driving control method of the present invention.

FIG. 3 is a flow chart of one embodiment of a method of the present invention for autonomously driving a motor vehicle having wheels.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

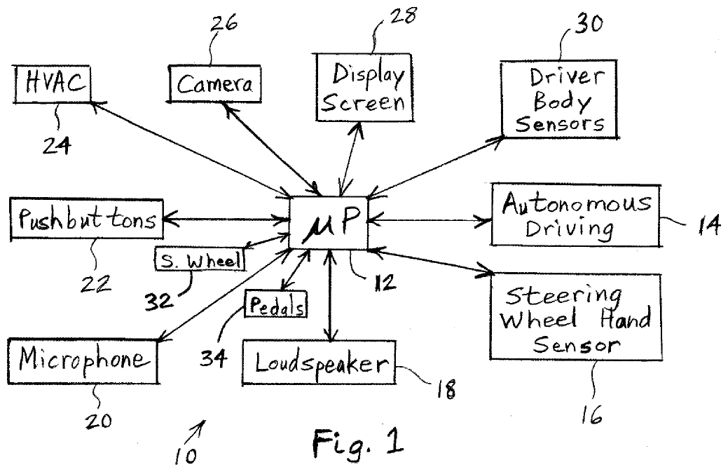

FIG. 1 illustrates one embodiment of an autonomous driving control arrangement 10 of the present invention for a motor vehicle, including an electronic processor 12 in communication with each of an autonomous driving system 14, a steering wheel hand sensor 16, a loudspeaker 18, a microphone 20, pushbuttons 22, a heating, ventilation and air conditioning (HVAC) system 24, a driver monitoring camera 26, a touch-sensitive display screen 28, driver body sensors 30, a steering wheel 32 and foot pedals 34. Steering wheel hand sensor 16 may detect the presence of the driver's hands on the steering wheel. Driver body sensors 30 may include a body temperature sensor, and a pulse sensor. Foot pedals 34 may include a gas pedal and a brake pedal.

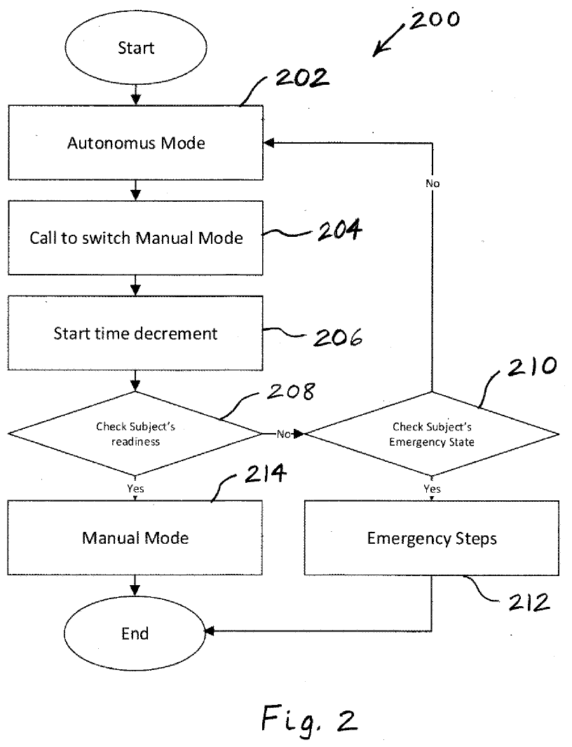

FIG. 2 illustrates one embodiment of an autonomous driving control method 200 of the present invention. In a first step 202, a motor vehicle is being operated in an autonomous driving mode wherein the vehicle itself controls its acceleration, braking and steering. Autonomous driving system 14 may control the operation of the vehicle in the autonomous driving mode.

Next, in step 204, there is a call to switch to a manual mode of driving in which a human driver controls the acceleration, braking and steering, as is conventionally known. For example, the driver may have hit a pushbutton 22 or put his hands on the steering wheel to be detected by sensor 16 to indicate that he would like to switch to the manual mode of driving.

In a next step 206, the start time is decremented. For example, an audible voice may be emitted from loudspeaker 18 counting down from 5 seconds.

In step 208, the human driver's readiness to take over the driving tasks is checked. For example, camera 26 may observe the driver's head and eyes for signs of drowsiness or not watching the road. Loudspeaker 18 may ask the driver to say something in particular or answer a question, and his audible response may be picked up by microphone 20 and checked by processor 12. Steering wheel hand sensor 16 may confirm that the driver's hands are gripping steering wheel 32.

If it is determined in step 208 that the human driver is not ready to take over the driving tasks, then operation proceeds to step 210 where it is checked whether the driver is in an emergency state. For example, driver body sensors 30 may detect whether the driver has a normal pulse and a normal body temperature. Camera 26 may detect whether the driver's eyes are open and directed to the road. If data collected by sensors 30 and/or camera 26 indicate that the driver may be having a health emergency, then processor may prompt the driver via a textual message on display screen 28 and/or an audible message via loudspeaker 18 asking the driver to indicate via visible gestures, indicate orally via microphone 20, or indicate tactilely via pushbuttons 22 or touch-sensitive display screen 28 whether he is having a health emergency.

If it is determined in step 210 that the driver is not having a health emergency, then operation returns back to step 202 where the autonomous mode of driving is continued. Alternatively, in another embodiment, operation returns to step 206 where time decrementing begins anew.

If, however, it is determined in step 210 that the driver is having a health emergency, then operation proceeds to step 212 where emergency steps are taken. For example, autonomous driving system 14 could automatically drive the vehicle to the nearest hospital if it can do so safely. Alternatively, autonomous driving system 14 could automatically drive the vehicle off the road and park in the nearest parking space. Processor 12 could then call 911 to summon emergency responders to the location of the parking space.

If, however, it is determined in step 208 that the human driver is indeed ready to take over the driving tasks, then operation proceeds to step 214 where the manual mode of driving is put into effect wherein the human driver controls acceleration, braking and steering of the vehicle, such as via conventional foot pedals 34 and steering wheel 32.

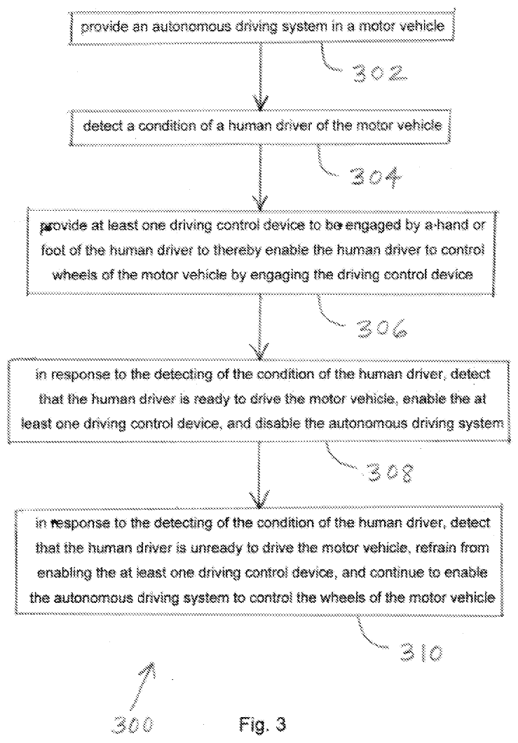

FIG. 3 illustrates one embodiment of a method 300 of the present invention for autonomously driving a motor vehicle having wheels. In a first step 302, an autonomous driving system is provided. For example, autonomous driving system 14 may be provided in a motor vehicle having wheels.

Next, in step 304, a condition of a human driver of the motor vehicle is detected. For example, camera 26 may observe the driver's head and eyes for signs of drowsiness or not watching the road. Loudspeaker 18 may ask the driver to say something in particular or answer a question, and his audible response may be picked up by microphone 20 and checked by processor 12. Steering wheel hand sensor 16 may confirm that the driver's hands are gripping steering wheel 32.

In a next step 306, at least one driving control device to be engaged by a hand or foot of the human driver is provided to thereby enable the human driver to control the wheels of the motor vehicle by engaging the driving control device. For example, the human driver may control acceleration, braking and steering of the wheels of the vehicle via conventional foot pedals 34 and steering wheel 32 provided in the vehicle.

In step 308, in response to the detecting of the condition of the human driver detecting that the human driver is ready to drive the motor vehicle, the at least one driving control device is enabled, and the autonomous driving system is disabled. For example, if the driver is watching the road, is responsive to questions, and has his hands on steering wheel 32, as determined by sensors, then the manual mode of driving is put into effect wherein the human driver controls acceleration, braking and steering of the vehicle, such as via conventional foot pedals 34 and steering wheel 32. Foot pedals 34 and steering wheel 32 are enabled, and autonomous driving system 14 is disabled.

In a final step 310, in response to the detecting of the condition of the human driver detecting that the human driver is unready to drive the motor vehicle, the at least one driving control device is not enabled, and enabling of the autonomous driving system to control the wheels of the motor vehicle is continued. For example, if the driver is not watching the road, is unresponsive to questions, or does not have his hands on steering wheel 32, as determined by sensors, then the manual mode of driving is not put into effect and the autonomous driving mode is continued. Foot pedals 34 and steering wheel 32 are not enabled, and autonomous driving system 14 is continued to be enabled.

The invention has been described herein as being applied to a motor vehicle having wheels. However, it is to be understood that the invention may be applied to anything that moves and that can be controlled by a human being. Vehicles that the invention may be applied to include, but are not limited to, tanks, missiles, tractors, earth-moving vehicles, airplanes, boats, ships, flying cars, transportation vehicles, robotic lawn mowers, lawn mowers, robotic vacuum cleaners, skateboards, all terrain vehicles (ATVs), motorcylces, Segways, electric bicycles, hang gliders, hot air balloons, jet skis, drones, golf carts, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An autonomous driving arrangement for a motor vehicle having wheels, the arrangement comprising:
an autonomous driving system;
at least one sensor configured to detect a condition of a human driver of the motor vehicle;
at least one driving control device configured to be engaged by a hand or foot of the human driver to thereby enable the human driver to control the wheels of the motor vehicle by engaging the driving control device; and
an electronic processor communicatively coupled to each of the autonomous driving system, the at least one sensor, and the at least one driving control device, the electronic processor being configured to:
receive signals from the at least one sensor;
in response to the signals indicating that the human driver is ready to drive the motor vehicle, enable the at least one driving control device and disable the autonomous driving system; and
in response to the signals indicating that the human driver is unready to drive the motor vehicle, refrain from enabling the at least one driving control device and continue to enable the autonomous driving system to control the wheels of the motor vehicle.

2. The arrangement of claim 1 wherein the at least one sensor comprises at least one of a camera, a steering wheel hand sensor, and a microphone.

3. The arrangement of claim 1 wherein the at least one driving control device comprises at least one of a steering wheel, an acceleration foot pedal, and a brake foot pedal.

4. The arrangement of claim 1 wherein the electronic processor is configured to, in response to the signals indicating that the human driver is unready to drive the motor vehicle, continue to enable the autonomous driving system to control a steering direction, speed of rotation, and direction of rotation of the wheels of the motor vehicle.

5. The arrangement of claim 1 further comprising
a heating ventilation and air conditioning system; and
a loudspeaker, wherein the electronic processor is configured to, in response to the signals indicating that the human driver is unready to drive the motor vehicle, cause the heating ventilation and air conditioning system to increase the flow of air being blown toward the human driver, and cause the loudspeaker to increase the volume of sounds being emitted from the loudspeaker.

6. The arrangement of claim 1 wherein the electronic processor is configured to receive a request from the human driver to switch from an autonomous driving mode to a manual driving mode, the request being received a predetermined time period before the signals from the at least one sensor are received, the predetermined time period being at least three seconds.

7. The arrangement of claim 6 wherein the electronic processor is configured to audibly count down the seconds during the predetermined time period via a loudspeaker.

8. A method for autonomously driving a motor vehicle having wheels, the method comprising:
providing an autonomous driving system;
detecting a condition of a human driver of the motor vehicle;
providing at least one driving control device configured to be engaged by a hand or foot of the human driver to thereby enable the human driver to control the wheels of the motor vehicle by engaging the driving control device;
in response to the detecting step detecting that the human driver is ready to drive the motor vehicle, enabling the at least one driving control device and disabling the autonomous driving system; and
in response to the detecting step detecting that the human driver is unready to drive the motor vehicle, refraining from enabling the at least one driving control device and continuing to enable the autonomous driving system to control the wheels of the motor vehicle.

9. The method of claim 8 wherein the detecting step is performed using a camera, a steering wheel hand sensor, and/or a microphone.

10. The method of claim 8 wherein the at least one driving control device comprises at least one of a steering wheel, an acceleration foot pedal, and a brake foot pedal.

11. The method of claim 8 wherein, in response to the detecting step detecting that the human driver is unready to drive the motor vehicle, the autonomous driving system is continued to be enabled to control a steering direction, speed of rotation, and direction of rotation of the wheels of the motor vehicle.

12. The method of claim 8 wherein, in response to the detecting step detecting that the human driver is unready to drive the motor vehicle, a heating ventilation and air conditioning system is caused to increase a flow of air being blown toward the human driver, and a volume of sounds being emitted from a loudspeaker is increased.

13. The method of claim 8 further comprising receiving a request from the human driver to switch from an autonomous driving mode to a manual driving mode, the request being received at least three seconds before the detecting step is performed.

14. The method of claim 13 further comprising audibly counting down the seconds after the request is received and before the detecting step is performed, the counting down being performed via a loudspeaker.

15. An autonomous driving arrangement for a motor vehicle having wheels, the arrangement comprising:
an autonomous driving system;
at least one readiness sensor configured to detect whether a human driver is ready to take over driving tasks of the motor vehicle;
at least one driving control device configured to be engaged by a hand or foot of the human driver to thereby enable the human driver to control the wheels of the motor vehicle by engaging the driving control device;
at least one driver body sensor configured to detect whether the human driver is having a health emergency; and
an electronic processor communicatively coupled to each of the autonomous driving system, the at least one readiness sensor, the at least one driving control device, and the at least one driver body sensor, the electronic processor being configured to:
receive readiness signals from the at least one readiness sensor;
in response to the readiness signals indicating that the human driver is ready to drive the motor vehicle, enable the at least one driving control device and disable the autonomous driving system;
in response to the readiness signals indicating that the human driver is unready to drive the motor vehicle, refrain from enabling the at least one driving control device and continue to enable the autonomous driving system to control the wheels of the motor vehicle;
receive health signals from the at least one driver body sensor; and
in response to the health signals indicating that the human driver is having a health emergency, use the autonomous driving system to drive the motor vehicle to a location where the human driver can be accessed by a human emergency responder.

16. The arrangement of claim 16 wherein the at least one driver body sensor comprises at least one of a pulse sensor and a body temperature sensor.

17. The arrangement of claim 15 wherein the electronic processor is configured to, in response to the signals indicating that the human driver is unready to drive the motor vehicle, continue to enable the autonomous driving system to control a steering direction, speed of rotation, and direction of rotation of the wheels of the motor vehicle.

18. The arrangement of claim 15 further comprising
a heating ventilation and air conditioning system; and
a loudspeaker, wherein the electronic processor is configured to, in response to the signals indicating that the human driver is unready to drive the motor vehicle, cause the heating ventilation and air conditioning system to increase the flow of air being blown toward the human driver, and cause the loudspeaker to increase the volume of sounds being emitted from the loudspeaker.

19. The arrangement of claim 15 wherein the electronic processor is configured to receive a request from the human driver to switch from an autonomous driving mode to a manual driving mode, the request being received a predetermined time period before the signals from the at least one sensor are received, the predetermined time period being at least three seconds.

20. The arrangement of claim 19 wherein the electronic processor is configured to audibly count down the seconds during the predetermined time period via a loudspeaker.
